(19) United States
(12) Patent Application Publication
(10) Pub. No.: US 2007/0250427 A1
(43) Pub. Date: Oct. 25, 2007

(54) Retirement planning system and method

(75) Inventor: Charles D. Robinson, River Hills, WI (US)

Correspondence Address: FOLEY & LARDNER LLP, 777 EAST WISCONSIN AVENUE, MILWAUKEE, WI, 53202-5306, US

(73) Assignee: The Northwestern Mutual Life Insurance Company

(21) Appl. No.: 11/811,453

(22) Filed: Jun. 8, 2007

Related U.S. Application Data
(63) Continuation-in-part of application No. 11/029,589, filed on Jan. 5, 2005.
(60) Provisional application No. 60/889,230, filed on Feb. 9, 2007.

(51) Int. Cl. G06Q 40/00

(52) U.S. Cl. 705/36 R

(57) ABSTRACT

A computer-implemented retirement planning system comprises data collection logic, modeling logic, and report generation logic. The data collection logic is configured to receive data pertaining to an individual planning for retirement. The retirement modeling logic is configured to process the data to generate parameters of a retirement plan. The retirement plan comprises a retirement income arrangement in which the amount of inflation-adjusted retirement income (from sources other than long term care insurance and health insurance) is larger during early years of the retirement plan and decreases as the maximum life expectancy of the individual is reached. The report generation logic is configured to generate a retirement plan report describing the retirement income arrangement.

### CROSS-REFERENCE TO RELATED APPLICATIONS

This application is a continuation-in-part of U.S. Ser. No. 11/029,589, filed Jan. 5, 2005, entitled “Retirement Planning System and Method,” pending, hereby incorporated by reference in its entirety. This application also claims priority to U.S. Prov. No. 60/889,230, filed Feb. 9, 2007, entitled “Retirement Planning System and Method,” also hereby incorporated by reference in its entirety.

### BACKGROUND OF THE INVENTION

Different individuals have different financial goals for retirement. For many people, an important financial goal during retirement is to have “income forever.” That is, such individuals wish to avoid running out of money while they are still alive. As part of this desire, individuals want to have enough money to pay long term care costs and health care costs during later years in life. At the same time, many people want to have money for leisure spending, particularly in the early years of retirement, to enjoy some of the things that they did not have the time to enjoy previously, such as traveling. Also, many people want to have money to pass on to heirs and/or charitable organizations.

Individuals may have different tolerances for different types of risk in connection with different ones of the above goals. For example, the retiree may be relatively risk averse in connection with the retiree's desire to avoid running out of money. On the other hand, in order to have the potential of greater investment returns, the retiree may be willing to live with more risk in connection with wealth to be passed on to heirs and/or charitable organizations. Different levels of risk tolerance have different implications for the types of investments that a retiree should be holding and the return on investment which the retiree can reasonably expect.

Planning for retirement is difficult due to the many seemingly conflicting goals and risks that a retiree faces. Retirees may have accumulated retirement savings well in excess of what is needed to provide for basic needs spending, but may be overly-cautious about spending it too quickly during early years of retirement, preventing them from fully enjoying the traveling and other activities that are supposed to be part of the golden years of life. Maximizing the benefit that can be derived from a given set of retirement assets can be difficult, particularly while taking into account a given retiree's tolerance for risk.

An ongoing need exists for retirement planning tools which help maximize the benefit that can be derived from a given set of retirement assets, while also taking into account a given retiree's tolerance for risk. An ongoing need also exists for retirement planning tools which allow for an accurate identification of the goals of the retiree and associated risks, which help distinguish between different investment goals, and/or which help plan more efficiently for each. Although certain advantages of systems and methods which incorporate the teachings herein are described, it will be appreciated that the teachings herein may be used to implement other systems and methods which do not exhibit some or any of these advantages, but rather which exhibit other advantages.

### SUMMARY OF THE INVENTION

One exemplary embodiment of the invention relates to a computer-implemented retirement planning system configured to generate a retirement plan for a couple including a first retiree and a second retiree. The system comprises data collection logic configured to receive data pertaining to the couple planning for retirement. The system further comprises retirement modeling logic configured to process the data to generate parameters of the retirement plan. The retirement plan comprises a retirement income arrangement in which the amount of inflation-adjusted retirement income from sources other than long term care insurance and health insurance is larger during early years of the retirement plan and decreases as the maximum life expectancy of the individual is reached. The retirement modeling logic is configured to take into account (i) a first set of spending and/or income parameters based on a first period of time in which both the first retiree and the second retiree are assumed to be alive, and (ii) a second set of spending and/or income parameters based on a second period of time in which one of the first and second retirees is assumed to have passed away. The system further comprises report generation logic configured to generate a retirement plan report describing the retirement income arrangement.

Another exemplary embodiment of the invention relates to a retirement product embodied in a retirement plan agreement between a retiree and a service entity that maintains the retirement product. The retirement product comprises a bundled set of investment products configured to generate retirement income through a plurality of phases of retirement including an active phase, a slowing down phase, and a passive phase. The retirement product further comprises a series of opt-in provisions and/or opt-out provisions. The series of provisions are configured to permit the entity to make investment decisions on behalf of the retiree pursuant to the retirement plan agreement. The retirement product may be configured to provide a retirement income arrangement in which the amount of inflation-adjusted retirement income from sources other than long term care insurance and health insurance is larger during early years of the retirement plan and decreases as the maximum life expectancy of the retiree is reached.

Another exemplary embodiment of the invention relates to a computer-implemented system for monitoring and maintaining retirement plans of retirees. The system comprises retirement plan maintenance logic configured to receive information concerning the retirement plans of the retirees and to receive information concerning actual financial performance of investments of the retirees. The retirement plan maintenance logic is also configured to perform comparisons of the actual financial performance of the investments of the retirees with a predicted performance of the investments of the retirees as set forth in the respective retirement plans. The retirement plan maintenance logic is further configured to generate notifications indicating deviations between the predicted financial performance and the actual financial performance of the investments.

### BRIEF DESCRIPTION OF THE DRAWINGS

FIG. 1 is a retirement planning system according to an exemplary embodiment.

FIG. 2 is a chart showing spending habits taken into consideration by the retirement planning system of FIG. 1.

FIG. 3 is a retirement plan generated by the system of FIG. 1.

FIG. 4 is a graph showing model retirement investment income generated by the retirement plan of FIG. 3.

FIG. 5 is a retirement planning process implemented by the system of FIG. 1.

FIGS. 6-8 are screen displays that may be provided by data collection logic of FIG. 1 to elicit information from a user.

FIGS. 9-11 are graphs showing hypothetical retirement investment income generated during different phases of by the retirement plan of FIG. 3.

FIG. 12 is a graph combining the graphs shown in FIGS. 9-11.

FIG. 13 is a graph showing a range of outcomes that may be achieved by the retirement plan of FIG. 3.

FIG. 14 is a chart showing spending habits taken into consideration by the retirement planning system of FIG. 1, and in which the spending habits are for a couple, according to another exemplary embodiment.

FIG. 15 is a retirement plan generated by the system of FIG. 1 for a couple having spending habits represented in FIG. 14.

FIGS. 16A-16B are retirement planning processes implemented by the system of FIG. 1 in connection with the retirement plan of FIG. 15.

FIG. 17 is a data processing system useable to create and maintain the retirement plans shown in FIG. 3 and FIG. 15.

FIGS. 18-20 are notifications that may be sent to retirees in connection with the implementation of mid-course corrections in the retirement plans of FIG. 3 and FIG. 15.

### DETAILED DESCRIPTION OF THE PREFERRED EMBODIMENTS

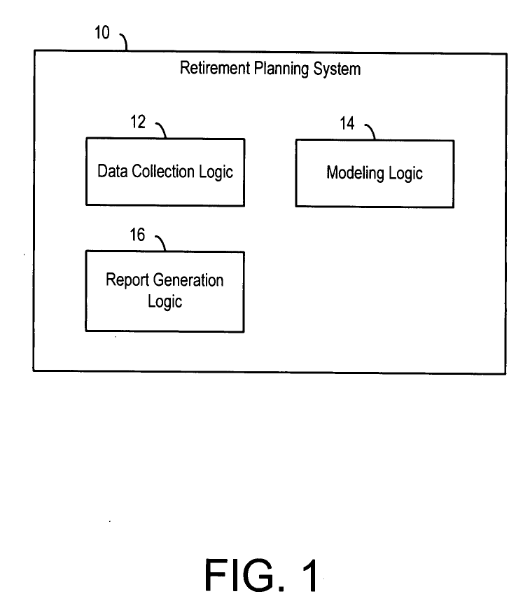

Referring to FIG. 1, a retirement planning system 10 is shown. System 10 may be implemented, for example, using a programmed computer (e.g., a desktop computer, laptop computer, etc.) provided with program modules including routines, programs, objects, components, data structures, etc. that perform particular tasks described herein. Planning system 10 may be accessed locally or remotely (e.g., logic for planning system 10 may be stored and accessed locally, or may be provided on a server and made available to a user remotely via the World Wide Web). The program modules may be custom programmed or may be based on commercially available software (e.g., a spreadsheet program operating on a data file which incorporates the teachings provided herein).

Retirement planning system 10 may be used to help a retiree plan for retirement. Herein, the term “retiree” is used to refer to any person planning for retirement (i.e., regardless whether that person is already retired). A retiree may plan for retirement alone or with the assistance of a third party, such as a financial planner, investment adviser, other representative of a financial services company, and so on.

Retirement planning system 10 comprises data collection logic 12, modeling logic 14, and report generation logic 16. Data collection logic 12 are used to receive input from the retiree (e.g., directly, or by way of a financial planner or investment adviser, etc.). Data collection logic 12 may comprise screen displays and data collection fields that are presented to the user in the form of a questionnaire. For example, data collection logic 12 may be used to collect financial data concerning the retiree (e.g., existing assets, sources of income including other retirement plans, spending habits, budgets, and so on). Data collection logic 12 may also be used to collect data concerning the retiree's goals (e.g., how much does the retiree wish to give to charities, how much does the retiree wish to leave to heirs, and so on). Data collection logic 12 may also be used to collect data concerning the retiree's tolerance for risk. For example, data collection logic 12 may be configured to pose a series of questions to a borrower that elicit information which may be used to evaluate the retiree's tolerance for risk. Such information may be obtained by posing a series of quantitative and/or qualitative questions to the borrower. Examples of such questions are described in detail below.

Modeling logic 14 is used to process the data provided by the retiree and collected by data collection logic 12. For example, modeling logic 14 may be used to convert data provided by the user into data useable to generate potential retirement plans. For example, as previously noted, data collection logic 12 may pose qualitative questions asking the retiree to select from predefined answer choices. Modeling logic 14 may comprise equations and weighting coefficients useable to generate a composite profile of the retiree's answers to certain types of questions. For example, a scoring algorithm may be used to assign weightings to different questions/answers and to generate numeric scores summarizing the user's answers which may be used in downstream calculations. For example, different scores may be generated reflecting the retiree's tolerance for different respective types of risk. Modeling logic 14 may then be used to use the processed data to generate different potential retirement plans for user comparison and selection. The different potential retirement plans may reflect different assumptions about investment performance, different mixes of investments, different risk tolerance levels, different spending patterns, and so on.

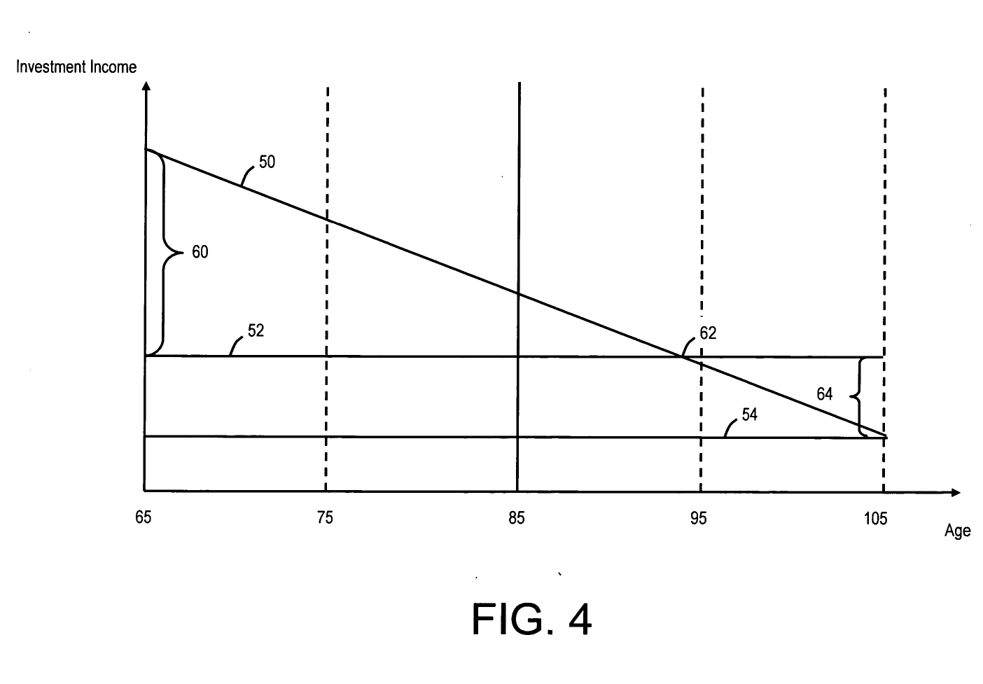

Report generation logic 16 is used to present output of modeling logic 14 to the user. Report generation logic 16 may be used to generate reports to provide to the retiree. For example, report generation logic 16 may be used to generate reports presenting the retiree with the different potential retirement plans generated by the modeling logic 14. Such reports may be presented to a user via a computer display screen, presented electronically via the internet, presented in hardcopy format using a printer, and so on. For example, such reports may include graphs of the type shown in FIGS. 4 and FIGS. 9-12. Such reports may be configured to include cautionary information, such as warnings that no investment strategy can guarantee a profit or protect against loss, limitations of the information presented (e.g., that the graphs do not account for taxes and investment costs which would reduce performance results), and so on. Data collection logic 12, modeling logic 14, and report generation logic 16 are described in greater detail below.

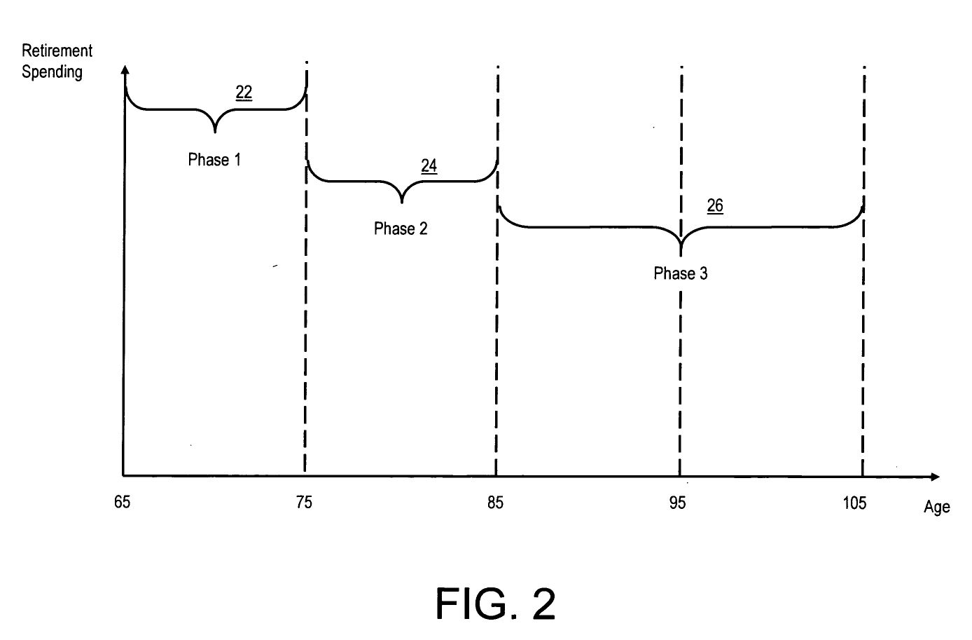

Referring now also to FIG. 2, retirement planning system 10 is configured to view retirement as comprising a number of phases. In FIG. 2, three phases are shown, although it will be appreciated that a different number of phases may be used. The three phases in FIG. 2 comprise an active phase 20, a slowing down phase 22, and a passive phase 24. During active phase 20, the retiree is assumed to be more active, enjoying activities such as travel, entertainment, sports, and so on. As a result, lifestyle spending is at its highest. Herein, the term “lifestyle spending” refers to that portion of spending during retirement which varies as a function of whether the retiree is in the active phase, slowing down phase or passive phase of retirement. “Lifestyle spending” is distinguished from “basic needs spending.” Herein, the term “basic needs spending” refers to that portion of spending which, absent financial difficulties, tends to be relatively constant regardless whether the retiree is in the active phase, slowing down phase or passive phase of retirement. Lifestyle spending and basic needs spending are both distinguished from health-related spending. “Health-related spending” refers to spending that is motivated or necessitated by health reasons. Examples of health-related spending include spending for medical care including hospitalization, prescriptions, treatments, long term care, and so on. As will be appreciated, the dollar value cutoff between basic needs spending and lifestyle spending may vary from retiree to retiree.

In the active phase, even after basic living needs have been met, the marginal utility of money remains high because money can be spent in a variety of different ways which bring enjoyment to the retiree. During the slowing down phase, the retiree is assumed to be less active. The retiree still engages in activities such as travel, entertainment, sports, and so on, but not to the same extent as during the active years, and so retirement spending decreases. After basic living needs have been met, the marginal utility of money decreases because the retiree has fewer options for spending money. During the passive phase, the retiree is assumed to be relatively inactive, engaging in a significantly smaller number of the activities that the retiree engaged in during more active years. In the passive phase, once basic living needs have been met, it is assumed that the marginal utility of money is relatively low.

In FIG. 2, by way of example, the active phase is shown to be from age 65 to age 75, the slowing down phase is shown to be from age 75 to age 85, and the passive phase is shown to be from age 85 and beyond. Transition ages for the different phases are shown to be age 75 and age 85. It will be appreciated that the ages at which an individual is assumed to be in each of the phases may be defined differently from individual to individual. Those individuals that are in better health may be able to enjoy an active lifestyle for a longer period of time. Additionally, some individuals may retire at younger ages. For example, for a retiree that retirees at 55, the active phase may be defined as starting at age 55.

As previously mentioned, absent financial difficulties, basic needs spending tends to be relatively constant. In the event of financial difficulties, however, many retirees may find ways to further reduce spending, if necessary. That is, if the retiree's investments perform poorly, a retiree may decide to cut back in one or more ways in order to reduce basic needs spending. As will be described in greater detail below, in creating retirement plan 20, a “worst case scenario” basic needs spending level may be defined. As used herein, “worst case scenario” refers to a scenario in which retirement investments perform at worst case levels. For example, in modeling/predicting performance of the retirement plan 20 at worst case levels, Great Depression era data or other historical data from periods of poor market performance may be used. The worst case scenario basic needs spending level is less than the. “normal” basic needs spending level (i.e., that which would be used assuming investments perform at better than worst case levels). For example, in defining worst case scenario basic needs spending, a retiree may decide that the retiree would be willing to move to less expensive housing (e.g., move to a smaller house or condominium), spend less money dining out (e.g., by not dining out as much), drive a less expensive car (e.g., drive a compact car that gets better gas mileage as compared to a luxury car), and/or wear less expensive clothing (e.g., off-the-rack clothing instead of designer clothing). In these situations, the retiree is giving up things which bring enjoyment, even in the passive phase of retirement, so the marginal utility of the money that is given up in a worst case scenario is non-zero. However, by defining a worst case scenario basic needs spending level which is less than a normal basic needs spending level, the retiree creates the opportunity to take on additional risk. This, in turn, creates the opportunity for greater investment returns.

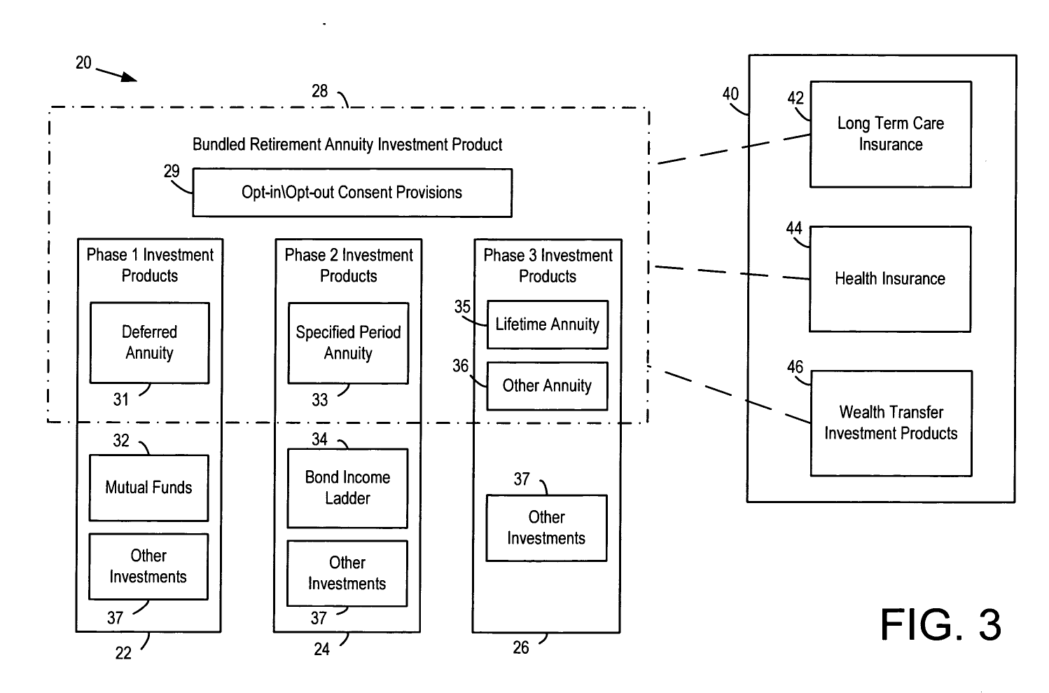

Referring now to FIGS. 3-4, a retirement plan 20 is shown that may be generated using the system of FIG. 1 and that reflects the considerations of FIG. 2. The retirement plan 20 comprises a series of investment mixes 22, 24, and 26 which correspond to different phases of retirement. Investment mixes 22, 24, and 26 may comprise various investments such as deferred annuities 31, mutual funds 32, specified period annuities 33, bond income ladders 34, lifetime annuities 35, other annuities 36, and other investments 37, as will be described in greater detail below. Other investments 37 may include pension income or other assets which the retiree intends to use for retirement. Investment mixes 22, 24, and 26 may be configured to reflect different assumptions about risk tolerance of the retiree, income needs, and so on. Again, while three phases are shown, it will be appreciated that a different number of phases may be used.

Retirement plan 20 also includes a number of additional investments 40 configured to meet other investment goals. Investments 40 include long term care insurance 42, health insurance 44, and wealth transfer investment products 46. Long term care insurance 42 and health insurance 44 are configured to pay for long term care and health care costs of the retiree. Accordingly, investment mixes 22, 24, and 26 provide income for daily living expenses and other personal spending, and are not needed to pay long term care and health care costs of the retiree. Likewise, wealth transfer investment products 46 are configured to allow the retiree to transfer wealth after passing away. For example, the retiree may want to provide an inheritance for heirs such as children or grandchildren, or may want to donate to a church, college, other charitable organizations, and so on. Investment products 46 may comprise life insurance, stocks, mutual funds, or other suitable investments.

By separating long term care insurance 42, health insurance 44, and wealth transfer investment products 46 as separate investments, the risk-benefit analysis for goals associated with these investments may be performed separately. For example, a retiree that has a goal of providing an inheritance to children or grandchildren may configure the investments to reflect the risk tolerance of the intended beneficiaries, which may be more aggressive than the risk tolerance of the retiree. At the same time, for the assets intended to meet the retiree's own future retirement needs, the retiree may configure at least a portion of the investments to have a more conservative risk profile.

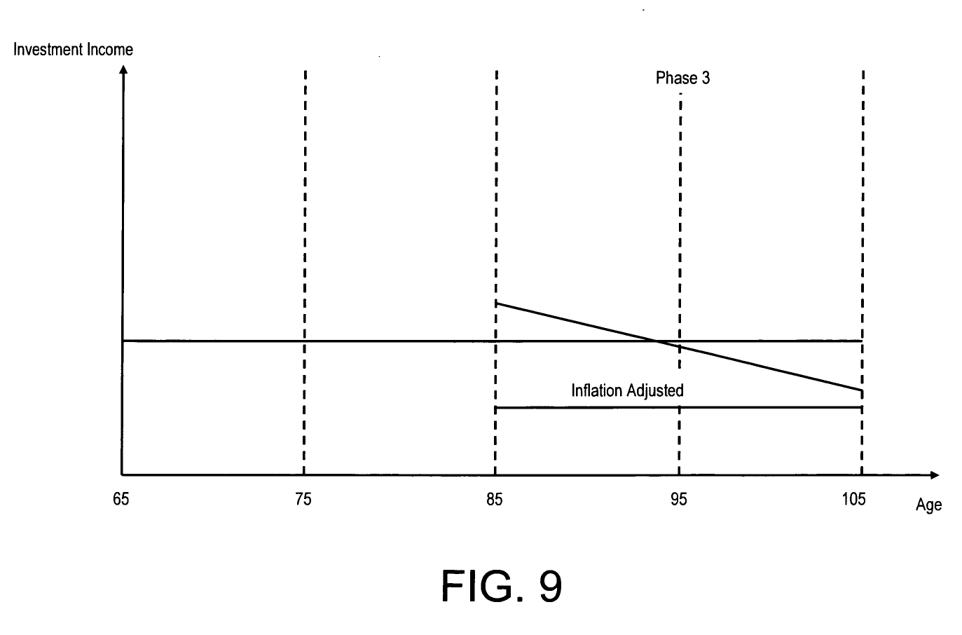

Referring now to FIG. 4, a graph is depicted showing income that may be generated by retirement plan 20 according to one model scenario. In the scenario of FIG. 4 (and FIGS. 9-12, discussed below), a moderate risk tolerance level is assumed, although it will be appreciated that the teachings herein may be applied for more conservative and more aggressive risk profiles. Each of the curves in FIG. 4 is inflation-adjusted. Curve 50 shows income generated by retirement plan 20 as a function of time. Curve 52 shows for comparison purposes income that would be generated by the same amount of assets if the assets were used to generate income in a time-invariant fashion (that is, if the retiree received the same amount of inflation-adjusted income each year throughout retirement). Curve 54 shows the level of income needed to provide for worst case scenario basic needs spending.

As shown in FIG. 4, retirement plan 20 generates greater income in early years, that is, during the active phase when the marginal utility of money is the highest. Brace 60 shows the difference in income in early retirement between the income generated by retirement plan 20 and the income that would be generated if the income were generated in time-invariant fashion. Retirement plan 20 steadily generates less income as time passes. At point 62, the amount of income generated by retirement plan 20 drops below the amount of income that would be generated if the income were generated in time-invariant fashion. When the retiree reaches age 105, the income generated by retirement plan 20 has dropped sufficiently such that it is only able to satisfy the basic needs spending of the retiree. (It may be noted that total spending may increase, as attributable to the existence of health care insurance and long term care insurance. Such other spending is not reflected in FIG. 4.) Brace 64 shows the difference in income in late retirement. At age 105, however, the marginal utility of money of the retiree is substantially less than during the early years of retirement, and may even be zero considering the fact that the retiree also has long term care insurance and health insurance.

For those retirees that have accumulated retirement savings in excess of what is needed to provide for basic needs spending, retirement plan 20 provides a way to maximize the benefit from those savings. The system is configured to maximize the benefit the retiree receives from the retiree's retirement assets by configuring retirement income to reflect the retiree's estimated marginal utility of money. The retiree has more money to spend during early years of retirement. Although the retiree has less money to spend during later years of retirement, the retiree derives less benefit from the money in the later years anyway. Also, statistically, the retiree stands a 50% chance of passing away before age 85. For those retirees that die before age 85, more benefit is derived by spending additional money before age 85 is reached.

Reports provided by report generation logic 16 may include information concerning how the retirement income varies in accordance with the marginal utility of money. For example, the reports may include text concerning various phases of retirement and the levels of activity in each phase. As yet another alternative, the reports may include information indicating how the relative levels of enjoyment derived from money may vary throughout retirement. As yet another alternative, the reports may include information describing the amount of money that is budgeted for lifestyle activities during early years of retirement (e.g., discretionary travel, entertainment, recreational activities, dining out, and so on).

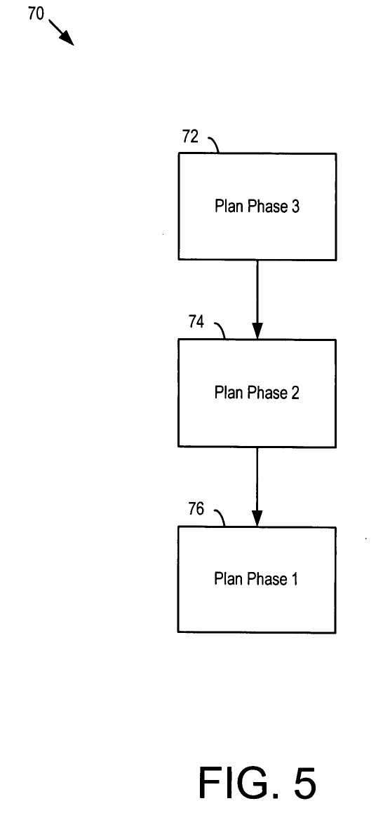

Referring now to FIG. 5, a retirement planning process 70 which may be performed using retirement planning system 10 and which may be used to generate retirement plan 20 is shown. In an exemplary embodiment, retirement planning process 70 starts (at step 72) with the final phase of retirement and solves the risk-based need of outliving retirement assets beyond age 85. In order to meet this goal, retirement plan 20 positions the retiree to purchase a lifetime annuity at the beginning of phase 3. A lifetime annuity provides payments for the lifetime of the retiree, and stops providing payments when the retiree dies. Typically, a lifetime annuity is configured as a risk-pooling arrangement in which benefits to individuals that live longer are funded by those that die early. Due to risk-sharing, lifetime annuities have an asset-multiplying effect. Various types of lifetime annuities exist, including annuities in which income is received over the lifetime of a single person, and joint and survivor lifetime annuities in which income is received over the lifetime of two persons. With the purchase of a lifetime annuity, the retiree is guaranteed an income stream for the remainder of the retiree's life.

Preferably, the retirement plan 20 allocates enough money for the purchase of the lifetime annuity such that the lifetime annuity provides an income stream that is adequate to meet the basic needs spending of the retiree for the remainder of the retiree's life. In order to determine the amount of money that the retiree should have on-hand at the beginning of phase 3 to purchase a lifetime annuity, the worst case scenario basic needs level of income that the retiree would like to receive during phase 3 of retirement is determined. The worst case scenario assumes that the investments perform at worst case levels (at or below long term historical lows, e.g., at “Great Depression” levels of performance) during intervening years. To determine this amount, as part of the retirement planning process, data collection logic 12 may be configured to pose questions to determine the level of income that meets the retiree's worst case scenario basic needs spending.

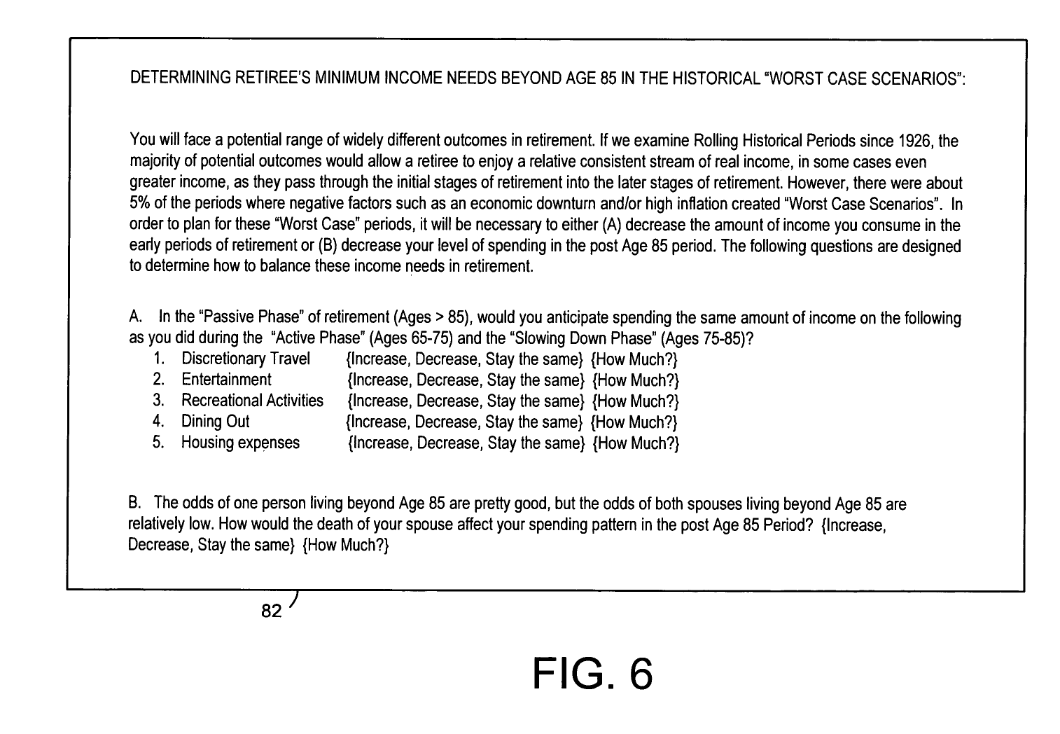

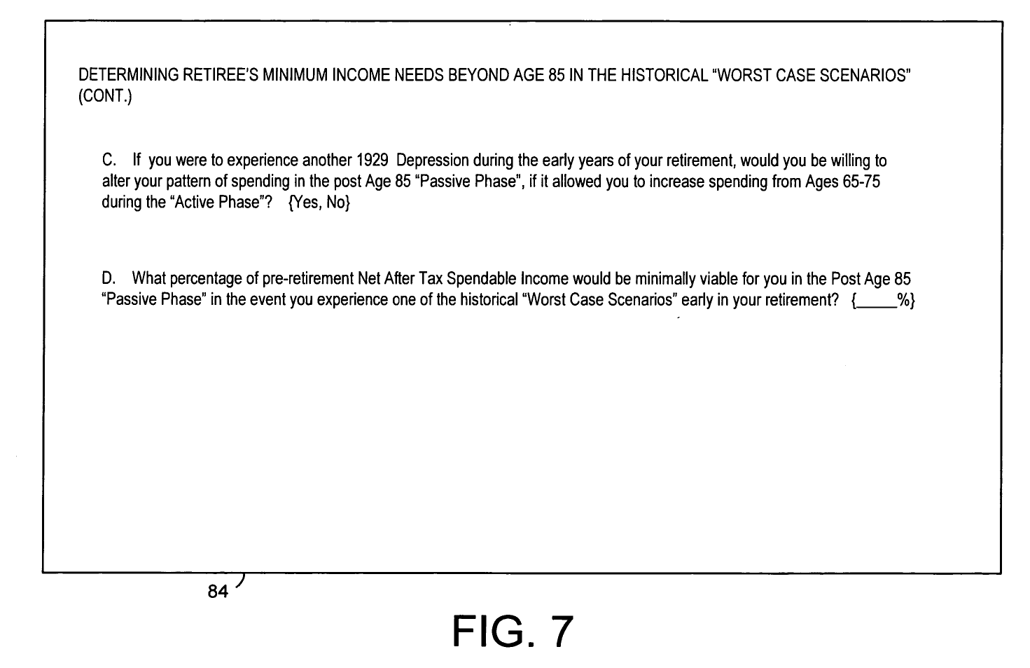

Referring now to FIGS. 6-7, screen displays 82 and 84 are shown that may be used to elicit information concerning what the retiree considers to be worst case scenario basic needs spending. As will be appreciated, the screen displays may be formatted in a variety of different ways. As shown in FIGS. 6-7, the user may be presented with a variety of different questions which ask the retiree to provide quantitative answers or to select from predefined qualitative answer choices (e.g., “Yes” or “No”). The worst case scenario basic needs spending amount may be determined by starting with budget information for the early years of retirement, and then estimating the retiree's worst case scenario basic needs spending by adjusting spending levels in accordance with the answers provided by the retiree. Once the adjustments have been made, data collection logic 12 may present the retiree with the worst case scenario basic needs spending information, and ask for confirmation that the amount calculated accounts for all of what the retiree considers to be needed and is otherwise considered by the retiree to be appropriate.

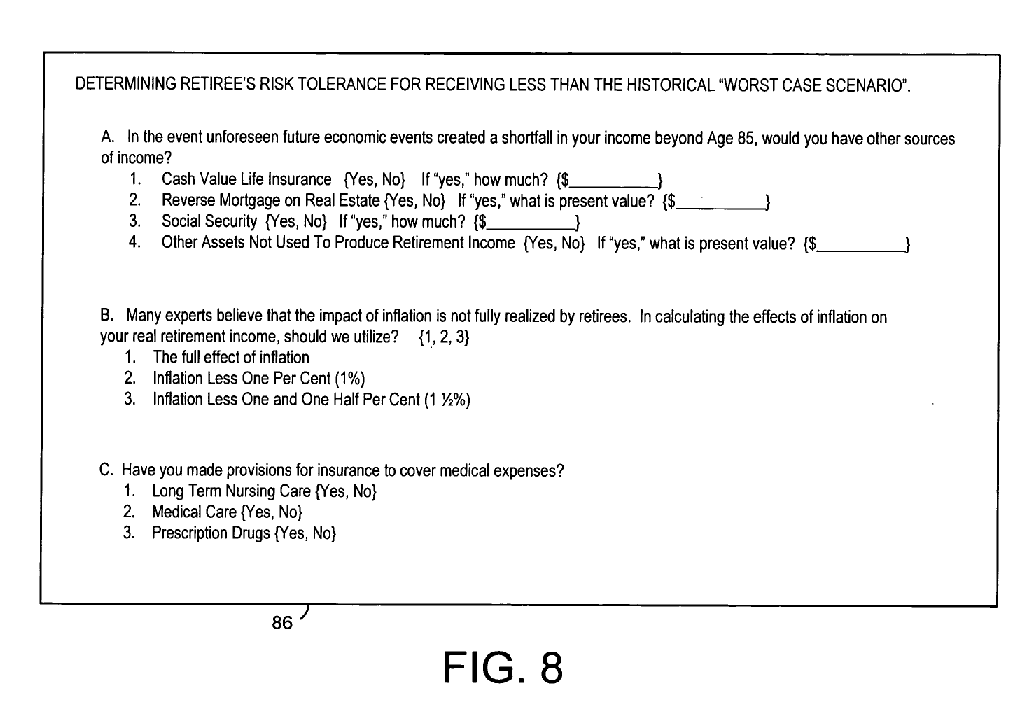

In determining the amount of income that needs to be generated by the lifetime annuity, other assumptions are also made. For example, such assumptions may include that the retiree will not live beyond a particular maximum life expectancy (in FIG. 4, age 105), assumptions about average inflation rates, and so on. As will be appreciated, these other assumptions also introduce uncertainty in the calculations for determining how much money to allocate for a lifetime annuity. Accordingly, to determine the retiree's risk tolerance in connection with phase 3 income, as part of the retirement planning process, data collection logic 12 may be configured to pose questions to determine the retiree's tolerance for risk in connection with the prospect that the retiree's income may be less than what is needed to meet worst case scenario basic needs spending due to erroneous assumptions about inflation, longevity, etc. FIG. 8 shows a screen display 86 which includes examples of such questions.

Based on the above information, the cost of a lifetime annuity that can be purchased at the beginning of phase 3 and that will provide income at least sufficient to meet worst case scenario basic needs spending until age 105 is determined. In turn, based on the cost of the lifetime annuity at the beginning of phase 3, the amount of money that needs to be invested at the beginning of phase 1 to yield enough money at the beginning of phase 3 to purchase the lifetime annuity may be determined. This amount of money may then be set aside (i.e., invested) to fund the lifetime annuity component of the retirement plan 20. The type of investments that may be made may vary depending on whether the retiree wishes to be conservative, moderate, or aggressive in their assumptions about investment performance.

In an exemplary embodiment, the lifetime annuity is funded with a deferred annuity which is purchased at the beginning of phase 1. The deferred annuity may comprise an annuitization payout option which allows the individual to exchange the value of the deferred annuity for the issuing company's guarantee to make payments to the retiree for the retiree's lifetime. The deferred annuity preferably has a guaranteed minimum settlement rate. The guaranteed minimum settlement rate is an interest rate at which payments are made under the annuitization payout option. It is “guaranteed” in that, if settlement rates currently offered at the time the annuitization payout option is exercised are less than the guaranteed minimum settlement rate, the retiree has the option to select the guaranteed minimum settlement rate to receive a higher payout. The deferred annuity may also have other features, such as a guaranteed minimum death benefit.

Although retirement plan 20 positions the retiree to purchase a lifetime annuity at the beginning of phase 3, in practice, the retiree may or may not ultimately decide to purchase the lifetime annuity when the time comes. Depending on the retiree's circumstances, the retiree may or may not need a lifetime annuity at the beginning of phase 3. As previously noted, the lifetime annuity allows people to participate in risk pooling, which allows a smaller amount of assets to last a longer period of time, if needed. However, if the retiree's investments have performed very well, the retiree may decide to defer indefinitely the purchase of a lifetime annuity, and potentially pass on remaining wealth to heirs, rather than losing it to other participants in the aforementioned risk-sharing arrangement. Alternatively, if the retiree is in poor health by the time age 85 is reached, and does not expect to outlive the retiree's assets, the retiree may decide not to purchase a lifetime annuity, and pass on remaining wealth to heirs. Alternatively, the retiree may prefer to have inflation-adjustment income. For example, if a deferred annuity is purchased as mentioned above, the retiree may select between an annuitization option (i.e., lifetime annuity) and taking inflation adjusted withdrawals. If the inflation adjusted withdrawal option is selected, the income stream is adjusted for inflation but there is no lifetime payment guarantee.

FIG. 9 shows a hypothetical income stream received by the retiree during phase 3. Although the discussion above has been phrased in terms of one lifetime annuity, in practice, it will be appreciated that multiple lifetime annuities may be purchased. Purchasing multiple lifetime annuities prevents the retiree from locking in an unduly low interest rate.

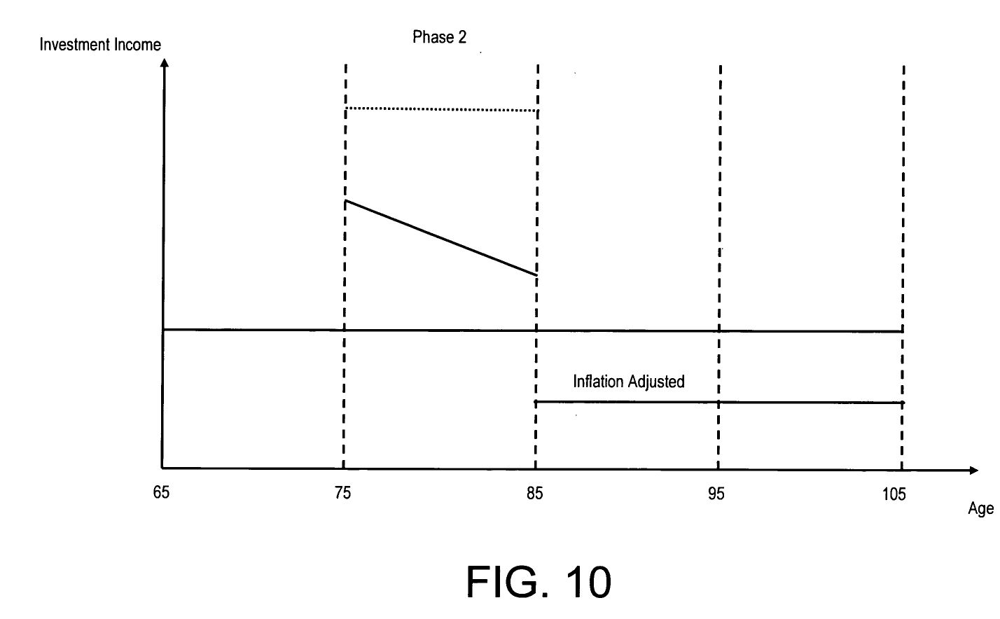

After parameters of the retirement plan 20 have been determined (e.g., the amount of money that is needed to fund a lifetime annuity in phase 3), retirement planning process 70 works backwards and plans phases 2 and 1 (steps 74, 76, respectively). FIG. 10 shows a hypothetical income stream received by the retiree during phase 2. For phase 2, the retirement plan 20 uses an income bridge to provide income for the retiree from age 75 to age 85. Again, the retiree may work backwards by determining how much income is desired during phase 2 and determining how much money will be needed to fund the phase 2 income bridge at the beginning of phase 2. The income bridge may be implemented using a specified period annuity, bond income, and/or other investments. With a specified period annuity, the retiree receives fixed income for a specified period of time, and benefits stop at the end of the specified period. Money to fund phase 2 retirement income is likely to be funded from qualified assets (e.g., 401(k) plans) and non-qualified assets (e.g., mutual funds).

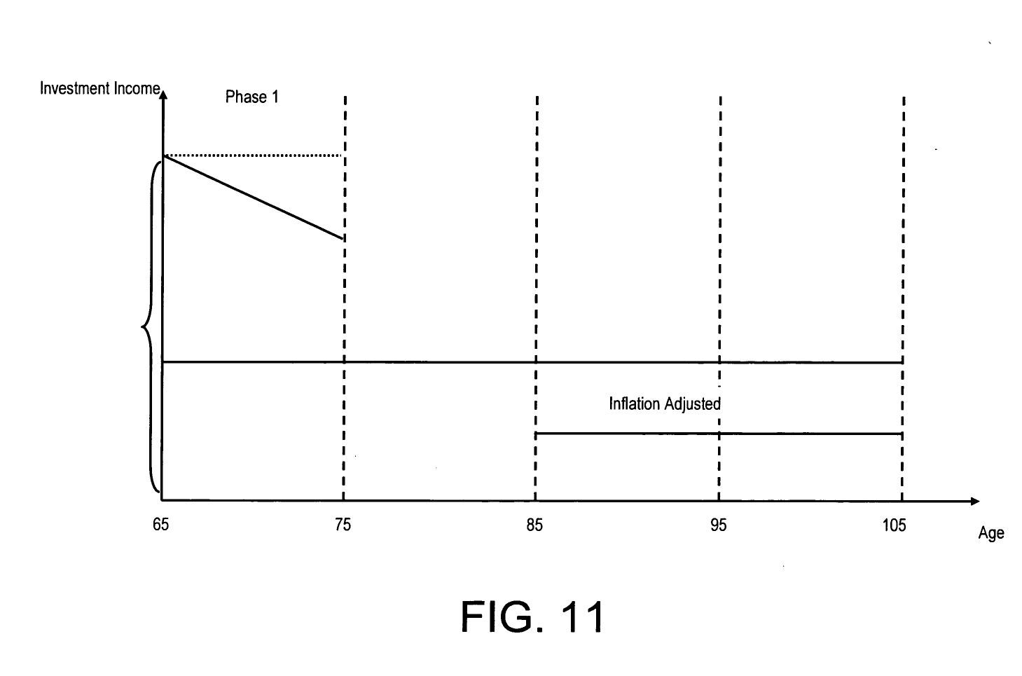

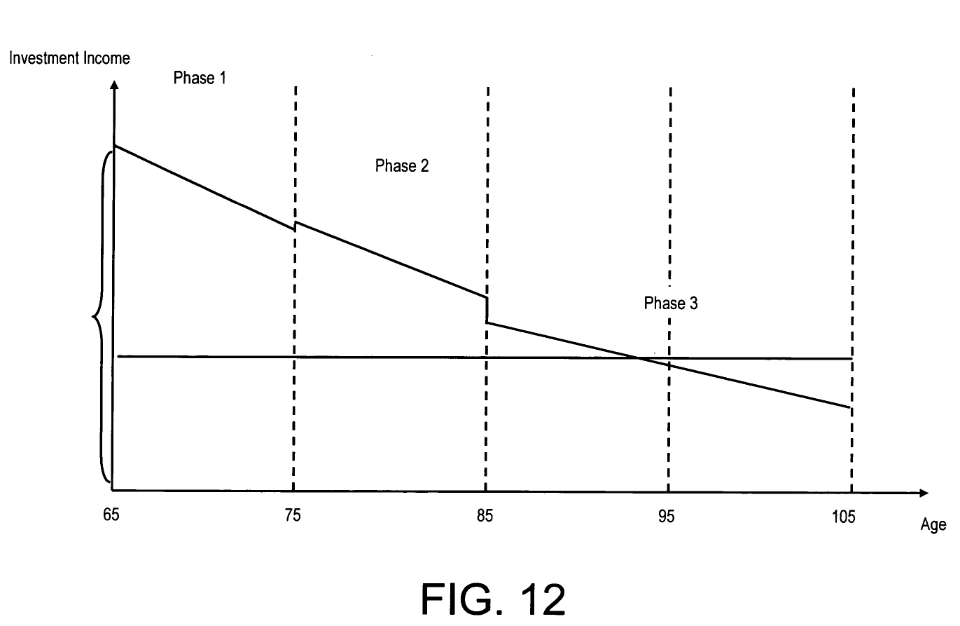

FIG. 11 shows a hypothetical income stream received by the retiree during phase 1. During phase 1, the retiree may decide to purchase a deferred annuity. With a deferred annuity, the investor has an option to receive a lump sum payment at the end of the annuity term. The retiree may also decide to invest in mutual funds or other investments. As will be appreciated, retirement planning process 70 may be iterative. That is, different scenarios for phases 1, 2 and 3 may be tested until an appropriate income/risk arrangement is reached. Additionally, investment performance and other assumptions that were factored into constructing retirement plan 20 may be revisited from time to time, such that retirement plan 20 may be updated. Desired income levels during various phases may be adjusted until an arrangement as shown in FIG. 12 is reached. In FIG. 12, income gradually decreases as the retiree gets older, without significant changes in income as the retiree moves from one phase to the next phase. FIG. 12 is similar to FIG. 4, except that it shows various minor discontinuities associated with transitions from one phase to the next resulting from investment performance.

The retirement planning process is preferably performed no later than when the retiree is at retirement age or, preferably, several years before. Retirement plan 20 preferably includes a seamless transition from qualified plan to deferred annuity to specified period annuity to lifetime annuity. All phases may be funded from qualified and unqualified assets. For example, pension income and other sources of income may also be factored in throughout each of the phases, if applicable.

By way of example, in the first year of retirement (e.g., at age 65), the worst case scenario basic needs spending amount may be determined, as described above in connection with FIGS. 6-7. A multiple of this amount (e.g., 4× this amount) is set aside and invested in accordance with the retiree's risk tolerance as described above in connection with FIG. 8. Then, a portion of the remaining asset balance may be invested in relatively conservative investments to fund phase 1 retirement and a remaining portion may be deferred and invested in more aggressive investments. For example, a moderately conservative investor may invest in 60% fixed income to fund phase 1 retirement income and may invest the remaining 40% in a more aggressive mix of investments to fund additional phase 2 and phase 3 retirement income. Because the investment horizons for phases 2 and 3 are quite long (10 years and 20 years at age 65, respectively), the money used to fund phases 2 and 3 may more appropriately be invested in more aggressive (higher risk, higher potential yield) investments. Small cap funds may be more volatile and more risky than large cap funds in the short term, but present more opportunity for high growth, especially when invested in over the long term. Over long periods of time, the probability of getting a high rate of return increases. By way of example, in addition to the 60% invested in fixed income for phase 1, 30% may be invested in large cap funds, and 10% may be invested in small cap funds for phases 2 and 3. Other aggressive mixes of investments may also be used. For example, for the remaining 40% for phases 2 and 3, 40% may be invested in large cap funds, 30% may be invested in small cap funds, and 30% may be invested in international funds. In one embodiment, the annual income from the phase 1 income bridge is capped at 7% of the original assets in order to prevent a higher-than-expected level of inflation from causing the retiree to spend too much in the early years of retirement. At age 75, the retiree moves more money to fixed income and large cap funds (e.g., 75% fixed income, 19% large cap funds and 6% small cap funds), reflecting a shorter investment horizon. The retiree may continue to defer the age 85 set aside, including earnings and remaining balance. Again, other mixes of investments may be used, including mixes which include international funds. At age 85, the retiree's financial position is evaluated to determine whether to annuitize for a lifetime income and, if so, what percentage to annuitize. In a worst case scenario, the retiree may invest in 100% fixed income.

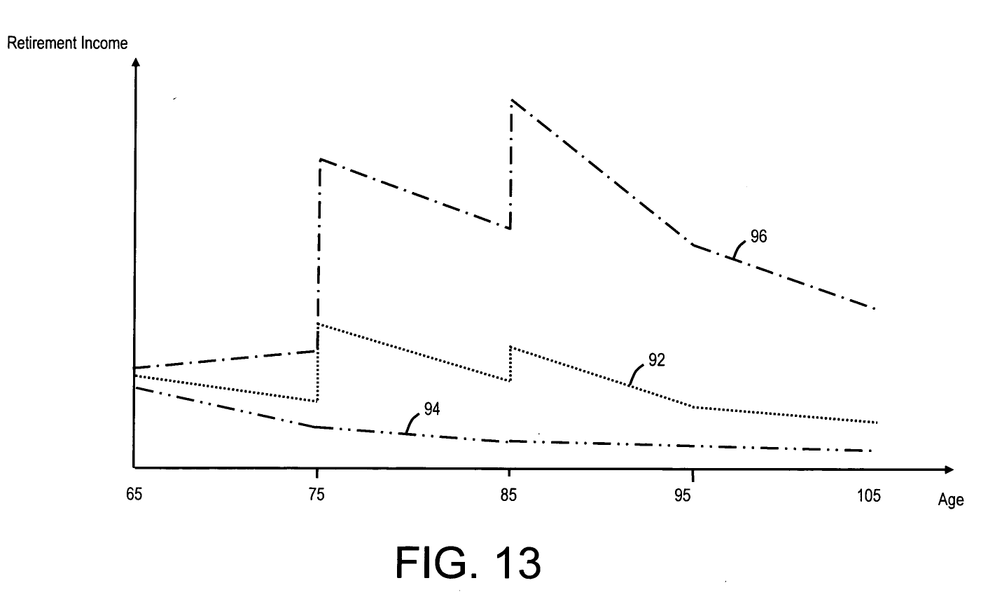

As shown in FIG. 13, depending on the performance of the retiree's assets, different ranges of outcomes are possible. Curve 92 shows a median case outcome, curve 94 shows a worst case outcome, and curve 96 shows a best case outcome. In the worst case scenario, curve 94, it is likely that the retiree will purchase a lifetime annuity at age 85 to provide for worst case scenario basic needs spending. In the best case scenario, curve 96, the retiree's investments have performed very well and the retiree is unlikely to purchase a lifetime annuity. The retiree's basic spending and then some are more than adequately met by returns on investments.

In FIG. 3, it may be noted the investment mixes 22, 24 and 26 each include one or more annuity products. In one embodiment, the annuity products in investment mixes 22, 24 and 26 are bundled to form a single product 28 which may be purchased by the retiree and which incorporates the different features of the individual annuity products. Annuity product 28 may include combinations of opt-out and opt-in provisions 29 in order to provide the retiree with the flexibility offered by purchasing the annuity products individually as well as the convenience of purchasing them in bundled form. Long term care insurance 42, health insurance 44, and/or wealth transfer investment products 46 may also be bundled and included in product 28, if desired.

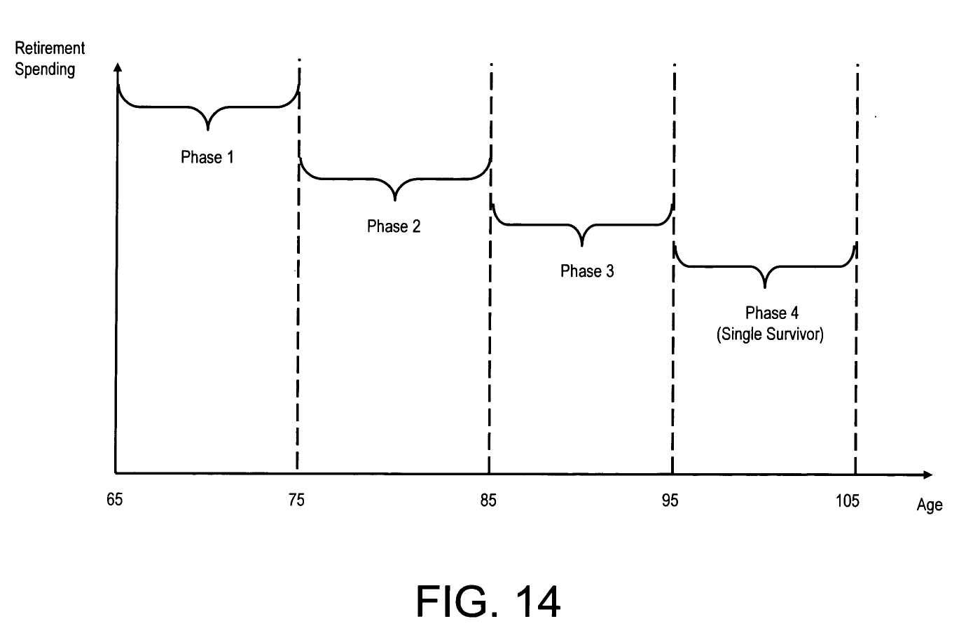

Referring now to FIG. 14, FIG. 14 is a chart showing spending habits taken into consideration by the retirement planning system of FIG. 1 according to another exemplary embodiment. As previously indicated, although FIG. 2 shows three phases, a different number of phases may also be used. For example, in FIG. 14, four phases are used.

In FIG. 14, as in FIG. 2, retirement is shown as comprising an active phase, a slowing down phase, and a passive phase. In FIG. 14, however, retirement is shown as further comprising a single survivor phase which occurs after the passive phase (e.g., at age 95 and beyond). Thus, whereas the arrangement of FIG. 2 may be used in retirement planning for one retiree or multiple retirees, the arrangement of FIG. 14 is particularly suited for use with multiple retirees. For purposes of explanation below, it is assumed that the multiple retirees are a married couple including two spouses. It will be appreciated, however, that the arrangement of FIG. 14 may also be used for planning for other combinations of individuals and partner arrangements.

For couples, it may be desirable to plan for the possibility that one spouse may outlive the other spouse for a significant period of time. For example, actuarial statistics may indicate that while, for any given couple, the probability of one of the spouses living past age 95 is relatively significant, the probability of both spouses living past age 95 approaches zero. Thus, it may be desirable to plan for the possibility that one but not both spouses will survive to a particular age (i.e., age 95 in the example in FIG. 14). This may be particularly desirable in situations where the death of one spouse may trigger changes in spending or available income/assets for the other spouse. For example, spending needs may be likely to decrease upon the death of one spouse, because only the spending needs of the surviving spouse remain. Likewise, available income/assets may increase upon the death of one spouse. For example, if a whole life insurance policy has been taken out on the life of one of the spouses, the death of that spouse will cause the proceeds of the life insurance policy to become available to the beneficiary/surviving spouse. On the other hand, if the insured spouse is the surviving spouse, that spouse will be able to access the cash value of the life insurance policy upon the death of the beneficiary spouse, because the life insurance policy no longer needs to be maintained to provide for the beneficiary spouse. Either way, therefore, there will be increased income and assets upon the death of one of the spouses. Planning for the possibility that one spouse may outlive the other spouse for a significant period of time (e.g., by planning for a single survivor phase of retirement) allows a different set of assumptions to be used about the risk tolerance of the retiree, income needs, and so on during the sole survivor phase of retirement. Further, because spending needs are likely to decrease and/or available income is likely to increase upon the death of one spouse, it is possible for the retirees to specify lower income needs past age 95, and therefore worry less about spending more during early years of retirement when the marginal utility of money is higher. As will be appreciated, although the death of one spouse is planned for in FIG. 14 by adding a fourth phase, it will be appreciated that the death of one spouse may also be planned for by redefining the three phases in FIG. 2, or in another manner.

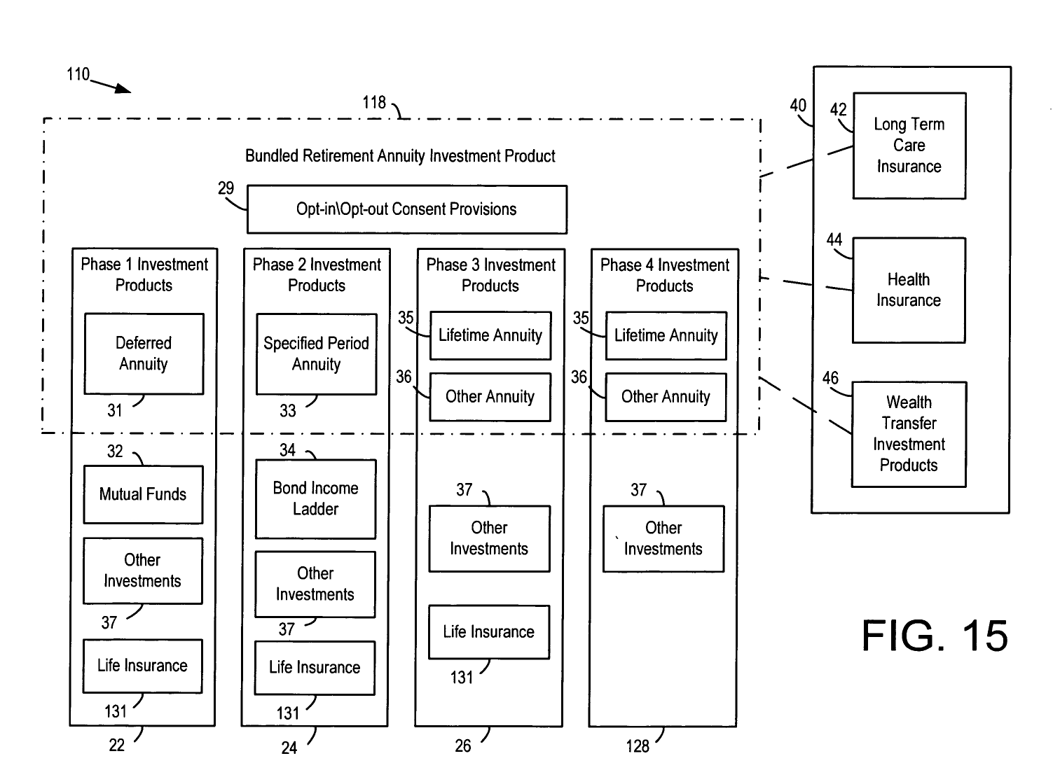

Referring now to FIG. 15, FIG. 15 is a retirement plan 110 generated by the system of FIG. 1 for a couple having spending habits represented in FIG. 14. As shown in FIG. 15, the retirement plan 110 may be similar in many respects to the retirement plan 20 described above in connection with FIG. 3. For example, the retirement plan 110 may comprise a series of investment products 31-37 (e.g., annuities, mutual funds, bond income ladders, and other investments) configured to provide income throughout a number of phases of retirement. Again, as with FIG. 3, it is assumed that the retirees may also invest in other products configured to provide for significant other retirement goals or expenses that may be encountered. For example, the retirement plan 110 may include long term care insurance 42 to provide for long term care expenses, health insurance 44 to provide for health care expenses, and wealth transfer investment products 46 to facilitate the transfer wealth to charitable organizations, foundations, children and grandchildren, and so on. As previously described in connection with FIG. 3, the retirees may separate projected needs for consumption on the one hand and for long term care and health care on the other hand. Separating such projected needs permits the retirees to plan for long term care and health care using a different set of inflation assumptions and a different funding strategy.

In the example of FIG. 15, the retirement plan 110 further comprises an investment mix 128 corresponding to phase 4 of retirement. Investment mix 128 for phase 4 may comprise a similar set of investment products as compared to the investment mix 26 for phase 3. However, investment mix 128 may be configured to reflect a different set of assumptions about risk tolerance of the retiree, income needs, and so on that apply during the single survivor phase of retirement, thereby allowing the retirees to specifically plan for the situation where one of the spouses has passed away. In the example of FIG. 15, the retirees may plan for increases in available income resulting from the existence of life insurance 131. As described above, the existence of the life insurance 131 may give the retirees the freedom to spend more money in early years in retirement without having to worry about later years of retirement (e.g., because the life insurance provides for an extra level of comfort against poorly performing investments). In some circumstances, a retiree may decide that the life insurance proceeds are so significant that the life insurance should be factored into the retirement plan 110 as a significant source of income during phase 4.

The retirement plan 110 may be configured such that phase 4 starts at a point where the probability (e.g., according to actuarial statistics) of both spouses being alive approaches zero. Accordingly, the probability of both spouses living for a longer period of time than planned (and having increased spending needs for a longer period of time than planned) is minimized. Herein, for purposes of describing an exemplary embodiment, it is assumed that the spouses are the same age. Accordingly, FIG. 14 does not show two different sets of age charts for the two spouses. As will be appreciated, however, the retirement plan 110 may also be used for spouses that are different ages.

In FIG. 15, in an exemplary embodiment, the products in investment mixes 22, 24, and 26 for phases 1-3 and investment mix 128 for phase 4 are bundled to form a single product 118. Retirement product 118 may be configured to be purchased by the retiree and may incorporate the different features of the individual investment products. Retirement product 118 may include combinations of opt-out and opt-in provisions 29 in order to provide the retiree with the flexibility offered by purchasing the investment products 31-37 individually as well as the convenience of purchasing them in bundled form. Long term care insurance 42, health insurance 44, and/or wealth transfer investment products 46 may also be bundled and included in product 128, if desired.

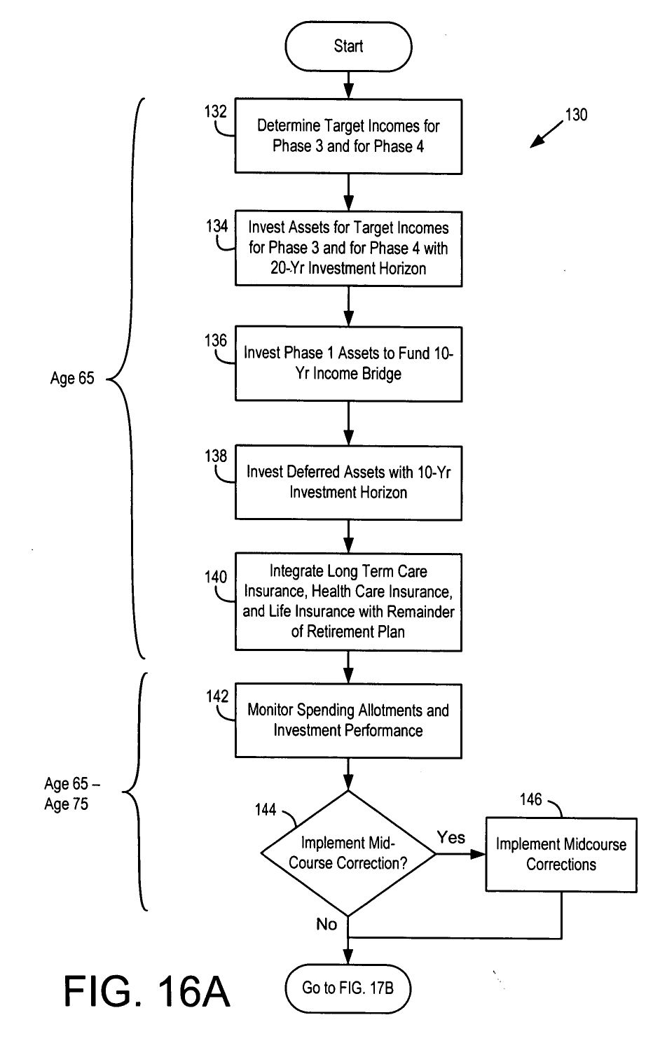

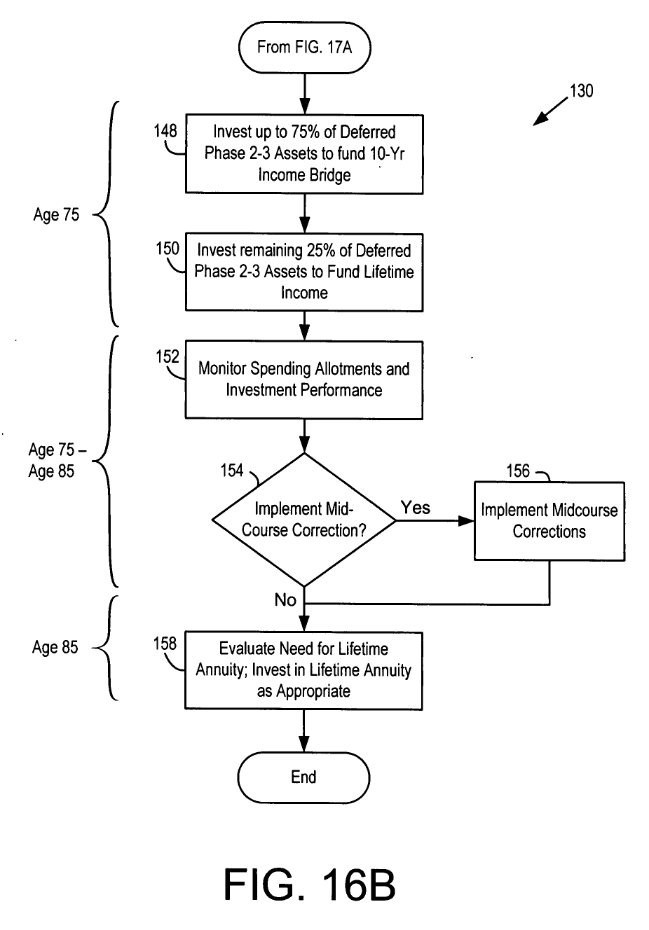

Referring now to FIGS. 16A-16B, in an exemplary embodiment, the retirement plan 110 may be created and maintained in accordance with a process 130. At steps 132-140, the retirement plan 110 is initially created by planning for the four phases of retirement in accordance with FIG. 14. Thus, initially, at step 132, target incomes for phase 3 and for phase 4 is determined, e.g., using the retirement planning system 10 of FIG. 1. In an exemplary embodiment, the target income is determined based on the risk of outliving assets after age 95 in a worst-case economic scenario. For example, several scenarios may be explored reflecting different potential risk tolerances of the retirees. The retirement planning system 10 may be configured to ask the retirees the same types of questions for phase 4 as are asked above in connection with the phase 3, including questions regarding spending needs (as described above in connection with FIGS. 6-7) and risk tolerance (as described above in connection with FIG. 8). However, given that the retirees are answering the questions based on a different set of assumptions, the answers provided to the questions are likely to be different. In addition to those questions discussed previously, other questions may also be asked. For example, questions may be asked concerning how income might change in the event of the death of one spouse (e.g., due to the presence of life insurance).

At step 134, the assets needed to fund the target incomes identified in step 132 are invested with a 20-year time horizon. For example, a multiple of the income (e.g., 600%) identified in step 132 may be invested. As described below, at age 85, this money and its earnings may be used in a worst-case scenario to fund an annuity to support one or both of the spouses in the final years of retirement. In the other scenarios (e.g., 85-90% of scenarios), which are more prosperous economic scenarios, the retiree may use the funds to provide retirement income using either annuity or non-annuity strategies.

Steps 136-140 may be performed in generally the same manner as steps 72-76 of FIG. 5. At step 136, the assets configured to fund phase 1 are allocated and invested to fund a 10-year income bridge. The phase 1 assets may be a portion (e.g., 60%) of the assets remaining after the investment in step 132 is made. At step 138, the assets configured to fund remaining phases of retirement are allocated and invested with a 10-year time horizon. These assets may be the remaining portion of the assets not invested in steps 134 and 136 (e.g., 40% of the assets remaining after the investment in step 132 is made). Hereinafter, the 600% of income set aside in step 134 and the 40% of assets set aside in step 138 are sometimes referred to in combination as the “deferred assets.” The assets invested at step 138 may be used at age 75 to purchase a 10-year income bridge. At step 140, various other assets (e.g., long term care insurance, health care insurance, and life insurance) are integrated with the remainder of the retirement plan 110. If necessary, income is reduced in steps 136 and 138 to close any gaps in managing the risks associated with long term care and health care costs (e.g., by allocating investments to fund the purchase of additional insurance). For health care and long term care, the assets that are required to fund long term care insurance 42 and health care insurance 44 may be invested in tranches and then accessed at different points in time. Because such assets do not need to be accessed until later, the assets may take advantage of more aggressive investment strategies. (If a retiree uses long term care insurance, then those assets may be accessed immediately after the long term care insurance is purchased and used to pay annual premiums.) The life insurance product may also be integrated to protect heirs, distribute wealth, and minimize estate taxes. Again, report generation logic 16 may be used to generate reports presenting the retiree with the different potential retirement plans generated by the modeling logic 14.

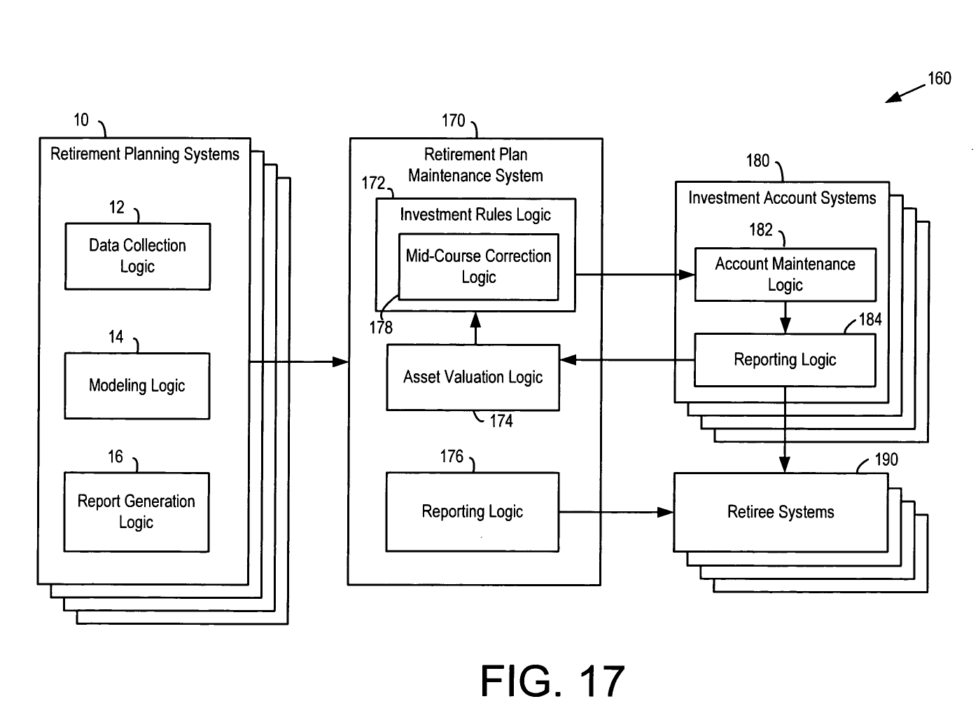

At step 142, from ages 65-75, spending allotments and investment performance are monitored and, at step 144, it is determined whether mid-course corrections are needed. If such mid-course corrections are needed, they are implemented at step 146. Steps 142-146 may be performed repeatedly over the ten year period spanning ages 65-75. For example, steps 142-146 may be performed on a weekly, monthly, quarterly, annual, or bi-annual basis. As described below, in one embodiment, steps 142-146 may be performed automatically for the retirees using retirement plan maintenance system 170 based on regular updates received from the investment account systems 180 concerning the financial performance of the investments 31-37 of the retirees. The implementation of mid-course corrections is described in greater detail below in connection with FIGS. 17-20.

In FIG. 16B, at step 148, at age 75, a portion of the deferred assets is invested to fund another 10-year income bridge. For example, up to 75% of the deferred assets may be used to fund the 10-year income bridge. The 10-year income bridge generates an income stream from age 75 to age 85. At step 150, the remaining portion (e.g., 25% of the deferred assets) may continue to be deferred to fund a lifetime income at age 85 using either annuity or non-annuity solutions. The funds invested may include the total cash value and earnings of the assets set aside at age 65 (step 134).

At step 152, from ages 75-85, spending allotments and investment performance are monitored and, at step 154, it is determined whether mid-course corrections are needed. If such mid-course corrections are needed, they are implemented at step 156. Again, steps 152-156 may be performed repeatedly over the ten year period spanning ages 75-85. Spending may be adjusted and/or gifts to children or charities may be accelerated, using a predetermined formula based on the value of deferred assets. Again, the implementation of mid-course corrections is described in greater detail below in connection with FIGS. 17-20. Financial and physical health may be evaluated at step 158 to determine whether a lifetime annuity should be purchased with part or all of the remaining assets.

Referring now also to FIG. 17, in an exemplary embodiment, a data processing system 160 is provided which is configured to facilitate management of the retirement plan 110. The data processing system 160 may be configured to monitor the financial performance of the investments in the retirement plan 110, provide notifications to the retiree upon the occurrence of certain events (e.g., when it is time to re-invest particular assets, when financial performance of invested assets does not meet expectations, and so on), and facilitate the implementation of mid-course corrections. As will be appreciated, the data processing system 160 may provide a safety net by providing an extra level of monitoring, thereby reducing the need for the retiree to closely monitor the performance of invested assets in the retirement plan 110.

The data processing system 160 comprises a retirement plan maintenance system 170, investment account systems 180, and retiree systems 190. For purposes of providing an example, the retirement plan maintenance system 170 and the investment account systems 180 are assumed herein to be provided by different entities. For example, the retirement plan maintenance system 170 may be provided by an entity that provides retirement planning services to retirees including, in the present example, maintaining and monitoring the retirement plan 110. It is assumed that the retiree makes investments through entities that are separate from the entity that provides the retirement plan maintenance system 170. For example, the retiree may make investments through investment services offering mutual funds, stocks, bonds, employee retirement plans, and so on. Accordingly, the investment account systems 180 are assumed to be provided by such investment services. The investment account systems 180 are configured to facilitate interaction with the investments 31-37 for purposes of obtaining updated account information, reallocating investments, and so on. Each investment account system 180 may, for example, comprise one or more servers associated with a respective one of the investment services that is configured to maintain account information for individual investors.

The retiree systems 190 may comprise computers (e.g., laptop computers, desktop computers, handheld computing devices, and so on) used by retirees to send and receive information from the retirement plan maintenance system 170 and the investment account systems 180. The data processing system 160 may also be coupled to the retirement planning system 10 of FIG. 1, as shown in FIG. 15. (In practice, the data processing system 160 may also be coupled to one or multiple instances of the retirement planning system 10, e.g., depending on whether the system 10 is located on the computers of individual financial advisors, or is centrally hosted on one or more servers.)

In operation, the retirement plan maintenance system 170 receives information concerning the retirement plans of individual retirees from the retirement planning system(s) 10. In an exemplary embodiment, the information received for each retirement plan includes information concerning each of the investments 31-37, including the amount of money invested, the term of the investment, the date of investment, the nature of the investment (e.g., investment product type), account information, and so on. In an exemplary embodiment, information is received concerning all of the retirees' investments, including those investments 37 that may not be associated with any particular investment service or other financial services institution (e.g., real estate investments, investments in partnerships or privately-held businesses, and so on).

After the retirement plan information is initially received, during the life of the retirement plan, the retirement plan maintenance system 170 may be configured to receive financial information concerning the performance of the investments 31-37 from the investment account systems 180. The retirement plan maintenance system 170 may serve as a central, dynamically updated repository of information concerning the retirement plan for the retirees. For example, financial performance information for the investments 31-37 may be received from the reporting logic 184 of the investment account systems 180 on a daily, weekly, monthly, quarterly or yearly basis. For other investments 37, the retiree systems 190 may be used by retirees to provide information not otherwise provided by the investment account systems 180. For example, if a portion of the investments of the retiree are in real estate (e.g., the retirees' home), the retirees may periodically use the retiree system 190 to update the estimated value of the real estate in the retirement plan maintenance system 170. Likewise, the retiree can also update estimated values in investments such as investments in partnerships or privately-held businesses. The retiree can also update any significant life events (death of a spouse, unanticipated changes in income or spending needs, and so on).

The retirement plan maintenance system 170 includes investment rules logic 172 configured to monitor the financial performance of the investments in the retirement plan 110 and evaluate the compliance of the actual performance of the investments 31-37 with the predicted performance as set forth in the retirement plan 110. The investment rules logic 172 may be coupled to account maintenance logic 182 of the investment account systems 180 to permit investment reallocation decisions to be communicated directly to the investment services that manage individual ones of the investments 31-37. In another exemplary embodiment, reallocation decisions may be made by investment rules logic 172 and communicated manually to investment account systems 180.

Investment rules logic 172 includes mid-course correction logic 178 which may implement business rules. The business rules may be configured compare actual values against thresholds defined in the retirement plan 110 to trigger an alert or other notification when mid-course corrections are needed or may be needed. For example, the mid-course correction logic 178 may be configured to generate an alert when the value of the deferred assets falls below a predetermined percentage of their original value. For example, if the value of the deferred assets falls below 30% of their original value, this may be a sign that the retirees are going to live through a very poor economic period during the first 10 years, and that the retirees should cut back spending and reconfigure the retirement plan to accommodate the poor economic period. On the other hand, the mid-course correction logic 178 may be configured to generate an alert when the value of the deferred assets exceeds a predetermined percentage of their original value. In this instance, the mid-course correction logic 178 may be configured to generate an alert that it may be possible to implement a mid-course correction to increase spending. The business rules stored in the mid-course correction logic 178 may also reflect assumptions underlying investment decisions at each step in process 130, such that a determination that facts surrounding the underlying assumptions have changed may also trigger an alert. For example, if one spouse has passed away, an alert may be triggered by mid-course correction logic 178 that a joint lifetime annuity should not be purchased but rather another investment product should be purchased. In an exemplary embodiment, the business rules stored in the mid-course correction logic 178 may be made configurable on a case-by-case basis for each retirement plan 110. For example, different parameters may be examined to trigger mid-course corrections and/or different trigger values for those parameters may be used. This permits default decisions to be put in place for a variety of different scenarios that may be potentially faced by a given retiree couple may be taken into account and addressed in advance.

The retirement plan maintenance system 170 includes asset valuation logic 174 which maintains an aggregate view of the total value of the investments 31-37. The asset valuation logic 174 may be coupled to reporting logic 184 of the investment account systems 180 to receive updates concerning the financial performance of the investments 31-37 of the retirees on a regular basis (e.g., weekly, monthly, quarterly, yearly, and so on). The retirement plan maintenance system 170 also includes reporting logic 176 which is configured to provide notifications and alerts to the retiree upon the occurrence of certain events, including events representing potential deviations from the retirement plan 110 and/or events that may trigger mid-course corrections, as described below.

In an exemplary embodiment, the mid-course corrections may be implemented automatically without necessarily requiring any affirmative action by the retirees. For example, the circumstances under which mid-course corrections may be taken, and the mid-course corrections that are to be made, may be defined in advance as part of the retirement product 118. The retirement product 118 may, for example, be embodied as an executed agreement between the retirees and the entity that provides the retirement plan maintenance system 170. The executed agreement may include negative authorizations to make mid-course corrections. For example, consent provisions (opt-out provisions) may be included that permit the mid-course corrections to be made absent instructions to the contrary.

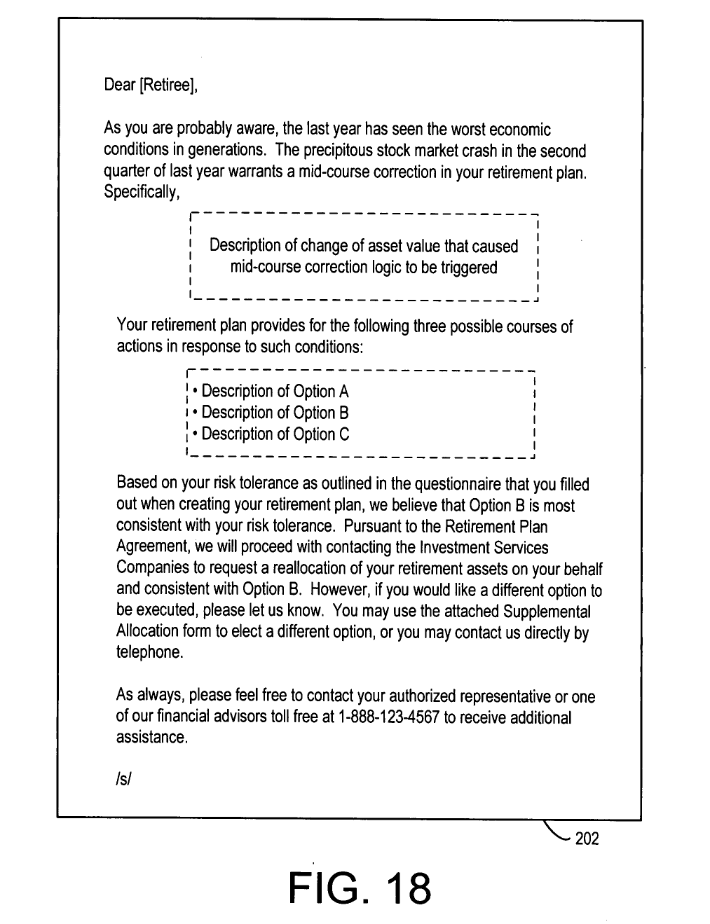

For example, if it becomes necessary to implement a mid-course correction to decrease spending, the retirement plan maintenance system 170 may be configured to generate a notification to the retiree. For example, a computer-generated letter may be sent to the retiree advising the retiree of the change in financial circumstances and indicating that the mid-course correction will be implemented unless instructions from the retiree to the contrary are received. The notification may also be sent in the form of a call from a call center, an e-mail, or in another suitable manner. FIG. 18 shows an example letter 202 that may be sent to a retiree in a situation where a mid-course correction is needed. In FIG. 18, the retirement plan 110 is assumed to provide for a number of possible options in the event that a triggering event for a pre-planned mid-course correction occurs. The letter 202 sets forth the different options, indicates which option is the default option that will be executed absent instructions to the contrary, and invites the retiree to fill out a form if the retiree wishes to provide instructions to pursue a different one of the options.

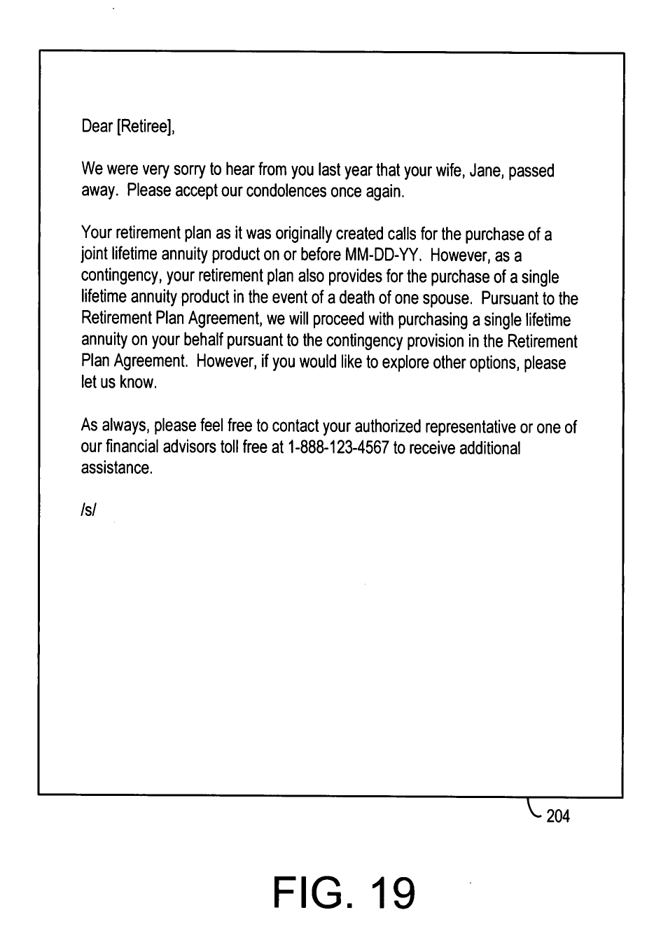

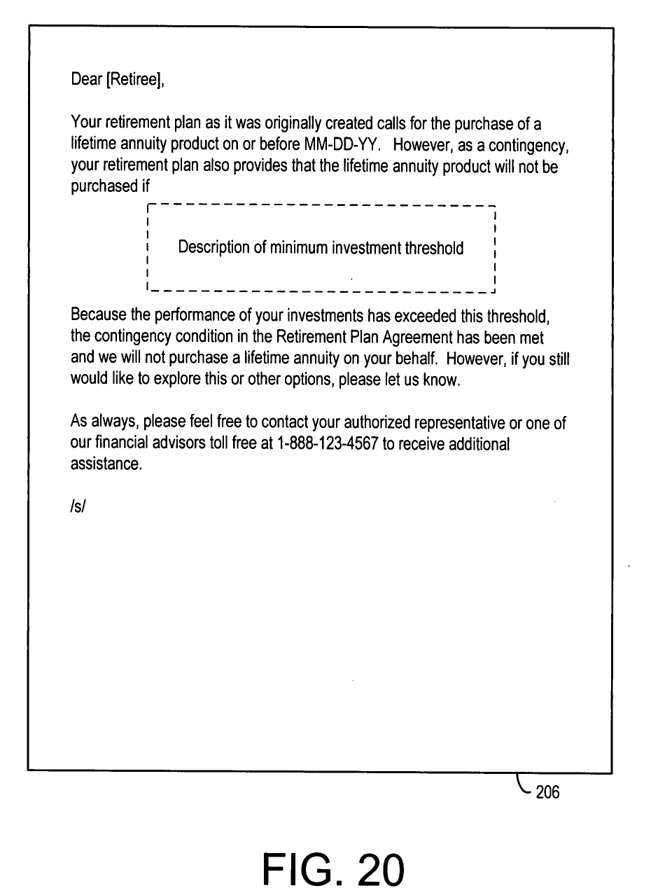

FIGS. 19 and 20 show letters that may be sent to the retiree, for example, at or near the performance of step 154. In FIG. 19, a letter 204 is sent to a surviving spouse indicating that assets will be re-invested in a single lifetime annuity rather than a joint lifetime annuity due to the death of the other spouse. In FIG. 20, a letter 206 is sent to a surviving spouse indicating that assets will not be re-invested in a lifetime annuity due to the financial performance of the investments 31-37. That is, the investments 31-37 have performed sufficiently well that the retiree may take the money that would have been used to obtain the asset-multiplying effect of a lifetime annuity and instead use the money for other purposes, e.g., to pass along to heirs. As will be appreciated, other notifications for other conditions triggering mid-course corrections may also be generated. Such notifications assist the retiree in monitoring the performance of invested assets in the retirement plan 110 and facilitate making mid-course corrections when appropriate.

Exemplary embodiments of the invention have been described with reference to drawings. However, describing the invention with drawings should not be construed as imposing on the invention any limitations that may be present in the drawings.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network and a wide area network. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include volatile and non-volatile memory including optical and magnetic disk drives for short and long term storage. The drives and their associated machine-readable media provide nonvolatile storage of machine-executable instructions, data structures, program modules and other data for the computer.

It should be noted that although the flow charts provided herein show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A computer-implemented retirement planning system configured to generate a retirement plan for a couple including a first retiree and a second retiree, the system comprising program logic stored in memory including:
data collection logic, the data collection logic being configured to receive data pertaining to the couple planning for retirement;
retirement modeling logic, the retirement modeling logic being configured to process the data to generate parameters of the retirement plan, the retirement plan comprising a retirement income arrangement in which the amount of inflation-adjusted retirement income from sources other than long term care insurance and health insurance is larger during early years of the retirement plan and decreases as the maximum life expectancy is reached, and the retirement modeling logic being configured to take into account (i) a first set of spending and/or income parameters based on a first period of time in which both the first retiree and the second retiree are assumed to be alive, and (ii) a second set of spending and/or income parameters based on a second period of time in which one of the first retiree and the second retiree is assumed to have passed away; and
report generation logic, the report generation logic being configured to generate a retirement plan report describing the retirement income arrangement.

2. The system of claim 1, wherein the second set of spending and/or income parameters reflect changes in income attributable to life insurance proceeds associated with the passing away of the retiree that is assumed to have passed away.

3. The system of claim 1,
wherein the modeling logic is configured to take into account the existence of a life insurance policy;
wherein, under the life insurance policy, one of the first and second retirees is the insured and the other of the first and second retirees is the beneficiary; and
wherein the second set of spending and/or income parameters reflect changes in income attributable to the availability of the cash value of the life insurance policy, the cash value becoming available to the insured upon the passing away of the beneficiary.

4. The system of claim 1, wherein the second set of spending and/or income parameters reflect a reduction in spending associated with the passing away of the retiree that is assumed to have passed away.

5. The system of claim 1, wherein the retirement plan is configured to vary the amount of inflation-adjusted retirement income provided to the first and second retirees for lifestyle spending and basic needs spending, and wherein the retirement plan is configured to vary the amount of inflation-adjusted retirement income in accordance with an estimated marginal utility of money for the first and second retirees during the retirement.

6. The system of claim 5, wherein the retirement plan report is configured to provide the first and second retirees with information describing how the amount of inflation-adjusted retirement income varies in accordance with the estimated marginal utility of money for the first and second retirees during the retirement.

7. The system of claim 1, wherein the retirement income steadily decreases towards a basic needs level as the maximum life expectancy of the first and second retirees is reached.

8. The system of claim 1, wherein the retirement plan report presents a comparison of the amount of inflation-adjusted retirement income received by the first and second retirees under the retirement plan with the amount of inflation-adjusted retirement income that would be received from the same starting retirement assets if the income were generated in an inflation-adjusted but otherwise time-invariant fashion.

9. The system of claim 1, wherein the amount of inflation-adjusted retirement income from sources other than long term care insurance and health insurance is at least two times as large during the early years of the retirement plan as compared to when the maximum life expectancy of the first and second retirees is reached.

10. The system of claim 1, wherein the amount of inflation-adjusted retirement income from sources other than long term care insurance and health insurance is at least three times as large during the early years of the retirement plan as compared to when the maximum life expectancy of the first and second retirees is reached.

11. The system of claim 1, wherein the data collection module is configured to present questions configured to elicit information concerning the tolerance for risk of the first and second retirees in connection with the prospect of receiving an amount of income which is less than a worst case scenario basic needs level as the maximum life expectancy of the first and second retirees is reached.

12. The system of claim 1, wherein the data collection module is configured to present questions configured to elicit information useable to ascertain what the first and second retirees consider to be a worst case scenario basic needs level of retirement income.

13. A computer-implemented system for monitoring and maintaining retirement plans of retirees, the system comprising program logic stored in memory including:
retirement plan maintenance logic, the retirement plan maintenance logic being configured to receive information concerning the retirement plans of the retirees and to receive information concerning actual financial performance of investments of the retirees, the retirement plan maintenance logic being configured to perform comparisons of the actual financial performance of the investments of the retirees with a predicted performance of the investments of the retirees as set forth in the respective retirement plans, and the retirement plan maintenance logic being configured to generate notifications indicating deviations between the predicted financial performance and the actual financial performance of the investments.

14. The system of claim 13, wherein the retirement plan maintenance logic is configured to receive updates concerning the financial performance of the investments from investment account systems associated with investment services entities that manage investments for the retirees.

15. The system of claim 13, wherein the retirement plan maintenance logic is configured to implement mid-course corrections in the retirement plan after detecting the deviations between the predicted financial performance and the actual financial performance of the investments.

16. The system of claim 15, wherein the retirement plan maintenance logic is configured to implement the mid-course corrections after a notification is communicated to the retiree advising the retiree that the mid-course correction is to be implemented.

17. The system of claim 16, wherein the mid-course correction is configured to be implemented pursuant to a negative consent provision of a retirement plan agreement with the retiree.

18. A retirement product embodied in a retirement plan agreement between a retiree and a service entity that maintains the retirement product, comprising:
a bundled set of investment products configured to generate retirement income throughout a plurality of phases of retirement including an active phase, a slowing down phase, and a passive phase;
a series of opt-in provisions and/or opt-out provisions, the series of provisions being configured to permit the entity to make investment decisions on behalf of the retiree pursuant to the retirement plan agreement.

19. The retirement product of claim 18, wherein the retirement product is configured to provide a retirement income arrangement in which the amount of inflation-adjusted retirement income from sources other than long term care insurance and health insurance is larger during early years of the retirement plan and decreases as the maximum life expectancy is reached.

20. The retirement product of claim 19, wherein the retirement product is configured to take into account (i) a first set of spending and/or income parameters based on a first period of time in which both the first retiree and the second retiree are assumed to be alive, and (ii) a second set of spending and/or income parameters based on a second period of time in which one of the first retiree and the second retiree is assumed to have passed away.

21. The retirement product of claim 20, wherein the retirement product is configured to vary the amount of inflation-adjusted retirement income provided to the first and second retirees for lifestyle spending and basic needs spending, and wherein the retirement product is configured to vary the amount of inflation-adjusted income in accordance with an estimated marginal utility of money for the first and second retirees during the retirement.

22. The retirement product of claim 20, wherein the retirement income for lifestyle spending and basic needs spending steadily decreases towards a basic needs level as the maximum life expectancy of the first and second retirees is reached.

23. The retirement product of claim 20, wherein the amount of inflation-adjusted retirement income from sources other than long term care insurance and health insurance is at least three times as large during the early years of the retirement plan as compared to when the maximum life expectancy of the first and second retirees is reached.

24. A computer-implemented retirement planning method for generating a retirement plan for a couple including first and second retirees, comprising:
receiving user inputs indicating a level of income the first and second retirees consider to be a worst case scenario basic needs level of income;
receiving user inputs indicating the first and second retirees' tolerance for risk in connection with the prospect that actual retirement income during a final phase of retirement may be less than the worst case scenario basic needs level of income;
receiving user inputs indicating the first and second retirees' predicted spending and/or income variations between a first period of time in which both the first retiree and the second retiree are assumed to be alive and a second period of time in which one of the first retiree and the second retiree is assumed to have passed away; and
generating a retirement plan based on (1) the basic needs level of income, (2) the first and second retirees' tolerance for risk in connection with the prospect that the actual retirement income during the final phase of retirement may be less than the worst case scenario basic needs level of income, and (3) the predicted spending and/or income variations between a first period of time in which both the first retiree and the second retiree are assumed to be alive and a second period of time in which one of the first retiree and the second retiree is assumed to have passed away.

25. The method of claim 24, wherein generating the retirement plan comprises generating parameters for the final phase of retirement, and then working backwards based on the parameters for the final phase of retirement to generate additional parameters for earlier phases of retirement.

26. The method of claim 24,
wherein the retirement plan is configured to vary the amount of inflation-adjusted retirement income provided to the individual in accordance with an estimated marginal utility of money for the individual during the retirement; and
wherein the method further comprises generating a retirement plan report which describes the retirement plan, the retirement plan report being configured to provide the individual with information describing how the amount of inflation-adjusted retirement income varies in accordance with the estimated marginal utility of money for the individual during the retirement.

27. The method of claim 24,
wherein the retirement plan comprises a retirement income arrangement in which the amount of inflation-adjusted retirement income from sources other than long term care insurance and health insurance is at least twice as large during early years of the retirement plan as compared to the amount of inflation-adjusted income that is received as the maximum life expectancy of the individual is reached.
wherein the method further comprises generating a retirement plan report which describes the retirement plan, the retirement plan report being configured to provide the individual with information describing the decrease in the amount of inflation-adjusted retirement income throughout retirement; and
wherein the retirement plan presents a comparison of the amount of inflation-adjusted retirement income received by the individual under the retirement plan with the amount of inflation-adjusted retirement income that would be received by the individual from the same starting retirement assets if the income were generated in an inflation-adjusted but otherwise time-invariant fashion.
